(19) United States
(12) Patent Application Publication
(10) Pub. No.: US 2025/0042672 A1
(43) Pub. Date: Feb. 6, 2025

(54) SECURITY INSPECTION SYSTEM AND SECURITY INSPECTION METHOD

(71) Applicant: HÖRMANN KLATT CONVEYORS GMBH, Neumarkt a. Wallersee (AT)

(72) Inventor: Peter Klatt, Neumarkt a. Wallersee (AT)

(21) Appl. No.: 18/709,110

(22) PCT Filed: Nov. 11, 2022
(86) PCT No.: PCT/EP2022/081614

§ 371 Date: May 10, 2024

(30) Foreign Application Priority Data
Nov. 12, 2021 (DE) 10 2021 129 503.3

(51) Int. Cl. B65G 47/48; B65G 47/68; G06Q 50/26

(52) U.S. Cl. CPC B65G 47/485; B65G 47/682; G06Q 50/265; B65G 2201/0264; B65G 2203/0266

(57) ABSTRACT

The security inspection system according to the invention consists substantially of
a luggage loading region for loading luggage of a person into at least one load carrier,
a luggage inspection station for an imaging examination of the luggage,
a luggage retrieval region with at least one buffer (22) for multiple load carriers loaded with luggage, wherein each buffer is paired with a plurality of removal stations (6a, 6b, 6c) and a providing system for transferring a load carrier loaded with luggage from the buffer to one of the removal stations, wherein regardless of the order in which the load carriers have been introduced into the buffer, the providing system is designed to transfer each load carrier which can be found in the buffer and which is loaded with luggage to each of the corresponding removal stations in any order, and
a transport system (8) for transporting the load carriers loaded with luggage from the luggage loading region to the luggage retrieval region via the luggage inspection station and for transporting back empty load carriers to the luggage loading region.

The invention relates to a security inspection system and to a security inspection method for inspecting a person's luggage.

The security inspection of people, in particular passengers and their hand luggage, is an integral part of every flight. Whether within Europe or internationally, the procedures and the appearance of the associated equipment have developed only marginally over the last few decades, which is not least due to regulatory requirements that specify the equipment to be used and the procedures to be followed. In recent years, however, innovations have been considered and the use of more modern technologies, such as the use of computer tomography to generate images for hand luggage inspections, has gradually been approved.

Due to the increasing number of passengers, airport operators have an increased interest in improving the efficiency of security inspections and reducing personnel costs through automation and monitoring of processes.

In EP 2 684 166 B1, an automated passenger inspection system is proposed for this purpose, wherein passengers deposit their luggage into a load carrier in a luggage loading region, wherein a personal identifier of the passenger is recorded and linked to the load carrier. While the luggage undergoes an imaging luggage inspection, the passengers undergo a people screening. Passengers then go to a luggage retrieval region, where the load carrier linked to the personal identifier is made available for emptying.

WO 2020/249192 A1 also discloses an automated security inspection system that, after the luggage retrieval region, provides an inspection device that is designed to determine the loading state and the degree of soiling of a load carrier.

The invention is based on the object of further increasing the efficiency of security inspections.

According to the invention, this object is achieved by the features of claims 1 and 15.

The security inspection system according to the invention consists substantially of
a luggage loading region for loading luggage of a person into at least one load carrier,
a luggage inspection station for an imaging examination of the luggage,
a luggage retrieval region with at least one buffer for multiple load carriers loaded with luggage, wherein each buffer is paired with a plurality of removal stations and a providing system for transferring a load carrier loaded with luggage from the buffer to one of the removal stations, wherein regardless of the order in which the load carriers have been introduced into the buffer, the providing system is designed to transfer each load carrier, which can be found in the buffer and which is loaded with luggage, to each of the corresponding removal stations in any order, and
a transport system for transporting the load carriers loaded with luggage from the luggage loading region to the luggage retrieval region via the luggage inspection station and for transporting back empty load carriers to the luggage loading region.

The security inspection method according to the invention is characterized by the following method steps:
in a luggage loading region, a person places their luggage in at least one load carrier,
the luggage in the load carrier is subjected to an imaging examination at a luggage inspection station,
the load carrier is transported with the luggage to a luggage retrieval region having at least one buffer for a plurality of load carriers and introduced there, wherein the buffer is paired with a plurality of removal stations,
the load carrier loaded with luggage is made available from the buffer at a removal station for emptying, wherein each load carrier loaded with luggage in the buffer—regardless of the order in which the load carriers have been introduced into the buffer—can be transferred in any order to each of the corresponding removal stations, and
the emptied load carriers are transported back to the luggage loading region,

In conventional systems, the order in which people/passengers arrive at the luggage retrieval region is determined by the order in which they pass through people screening. However, it often happens that individual persons have to undergo a manual people screening process, wherein the next person cannot be screened until the manual follow-up screening has been completed. In addition, the load carriers with the luggage therein are made available in the luggage retrieval region in the order in which they passed through the luggage inspection station. With the current systems, it is therefore virtually impossible to overtake people who have to undergo lengthy people screening.

According to the invention, the load carriers loaded with luggage are therefore first fed to a buffer in the luggage retrieval region. The people/passengers can then go to any removal station and the load carrier with their luggage is then made available from the buffer at this removal station.

If there are a large number of removal stations, these could also be divided into two or more zones, each of which is paired with a buffer. On the way between the people screening and the luggage retrieval region, people are then told which zone they need to go to. However, they can also select any free removal station in the assigned zone and the providing system will provide the corresponding load carrier.

The system according to the invention thus makes it possible to overtake people who, for example, have to undergo an additional, manual people screening or who simply move more slowly to the luggage retrieval region.

Compared to the conventional system currently on the market, in which all incoming load carriers are placed in a row in an accumulation region, the system according to the invention also has the advantage that luggage can be removed undisturbed and there is no need to worry about individual pieces of luggage being stolen.

To ensure that the principle of free choice of removal station works satisfactorily and that the load carrier with the corresponding luggage is made available in the shortest possible time, the buffer and the providing system are designed such that any load carrier in the buffer-regardless of the order in which the load carrier entered the buffer—can be transferred to any of the existing removal stations in any order, so that it does not matter which removal station the person goes to and requests their load carrier.

Further embodiments of the invention are the subject matter of the dependent claims.

In the experiments on which the invention is based, it has been found to be advantageous if the buffer has a plurality of buffer spaces arranged in one plane, wherein the buffer can in particular have a plurality of parallel rows of buffers, each having a plurality of buffer spaces.

According to a further embodiment of the invention, the providing system has at least one conveyor unit for displacing the load carriers in the x-direction and at least one transfer unit for displacing the load carriers in the x- and y-directions, wherein the transfer unit is provided between the buffer and the removal stations and is designed to transfer the load carriers fed from the buffer to the transfer unit to each of the removal stations. The transfer of a requested load carrier to the removal station preferably also takes place in one plane, which ensures a particularly fast transfer.

In a further embodiment of the invention, the providing system has at least one lifting mechanism for lifting one or more load carriers in the z-direction, wherein the lifting mechanism is designed to lift one or more load carriers within a row of buffers into a raised position, wherein the clearance created during lifting is sufficient for passing other load carriers below the load carrier in the raised position. In this way, load carriers introduced into the buffer later can overtake other load carriers introduced earlier if these are requested beforehand at one of the removal stations. In principle, instead of lifting a load carrier, it would of course also be conceivable to lower it in order to allow the load carriers therebehind to pass.

The buffer preferably has at least twice, preferably at least three times as many buffer spaces as removal stations, with the number of buffer spaces and removal stations ultimately being based on the actual demand and the available space.

Furthermore, each buffer space can be designed with a separately controllable conveyor unit for moving the load carriers in the x-direction. In addition, each removal station can have a displacement unit for displacing the load carriers between the removal station and the transfer unit. This allows the load carriers to be conveyed in the x-direction from the buffer to the transfer unit and from there either further in the x-direction to the next removal station or first in the y-direction up to the requesting removal station and then in the x-direction to this removal station.

For a particularly fast transfer of the load carriers from the buffer to the removal stations, belt and roller conveyors or a combination of both conveyor types have proven to be particularly advantageous.

Since there is usually only limited space available for transporting the load carriers loaded with luggage and the empty load carriers to be returned, it makes sense for the transporting back of the empty load carriers to take place at least partially in a second plane, wherein this second plane could be located both above and below the transport route for the loaded load carriers. In one embodiment of the invention, the transfer unit cooperates with at least one empty crate lifting mechanism that is designed to transfer emptied load carriers that have been displaced from the removal stations to the transfer unit, wherein the empty crate lifting mechanism is connected to a return transport route for transporting back empty load carriers to the luggage loading region. Within the scope of the invention, however, it would also be conceivable that the emptied load carriers are already at the removal station, for example lowered, and transferred to the return transport route. This would allow the transfer unit to be used in parallel for the transfer of the next load carrier.

According to the preferred embodiment of the invention, a first identification device for detecting a personal identifier, in particular biometric characteristics, of the person is provided at each drop-off station, which identification device interacts with a data processing device for linking the personal identifier of the person with the load carrier in which the person's luggage is located. At each drop-off station, a personal identifier of the person can thus be detected by means of the first identification device, wherein the personal identifier of the person is linked to the load carrier in which the person's luggage is located by means of the data processing device.

In this way, the load carrier loaded with the luggage is clearly assigned to the person to whom the luggage belongs. The first identification device can either be designed to detect the person's personal identifier for the first time or it can be used to identify the person if the personal identifier is already stored in the system. For example, a person's personal identifier could be detected when entering the airport building or when dropping off the large luggage. It is also conceivable that the person generates their personal identifier themselves in advance of a trip, for example using a smartphone, and uploads it to the airline. In addition to the person's biometric characteristics, other personal identifiers, such as a code on the boarding pass, would also be conceivable. However, biometric characteristics have the advantage that they can be easily captured with a camera, eliminating the need for the person to have their boarding pass or other token scanned.

To ensure that the correct load carrier is provided in the luggage retrieval region, each removal station is preferably equipped with a second identification unit for detecting the personal identifier of the person standing in front of the removal station, wherein the second identification unit is linked to the providing system in order to transfer the load carrier linked to the person's personal identifier from the buffer to this removal station. Furthermore, input and/or output units, in particular monitors and loudspeakers, can be provided at the existing removal stations, which input and/or output units are designed to provide information to the person and/or to confirm the emptying process of the load carrier by the person. In particular, the input and/or output units can be used to draw the person's attention to the fact that there are still items of luggage/objects in the load carrier. Once the retrieval is complete, it is possible, for example, to wish a good flight and/or to display the departure gate, if this information is available. Another option would be to include advertising, which would open up an additional source of income.

Furthermore, a monitoring device can be provided at each removal station to alert the person standing at the removal station if, for example, not all items have been removed from the load carrier. If the load carrier is recognized as empty by the monitoring device, the removal of the load carrier can also be initiated automatically, thus avoiding the passengers having to manually complete the removal process after removing their items.

In an advantageous embodiment, a sensor unit, which is formed, for example, by the second identification unit, can be provided at the existing removal stations, which sensor unit is designed to determine the presence of a person in front of the removal station and which is linked to the monitoring unit and the providing system such that the emptying process is completed by removing the emptied load carrier if the sensor unit does not detect a person in front of the removal station and the load carrier is empty. In this way, the removal station can be made available for the next person as quickly as possible. Of course, it is also conceivable that after emptying the load carrier at the removal station, the person completes the emptying process by making an input at an input unit or by closing a lid or cover and the load carrier is then transported away.

In the luggage retrieval region, at least one waiting area can also be provided for people who wish to collect their luggage, wherein the waiting area is paired with all existing removal stations or all removal stations paired with a zone and at least one third identification device is provided in the waiting area, which detects the personal identifier of at least the person who can go to one of the removal stations next, and wherein the third identification device interacts with the providing system for the accelerated transfer of the load carrier linked to the personal identifier. It would therefore be possible for a load carrier stored in the rear part of the buffer to be conveyed forward onto the transfer unit, so that the load carrier then only has to be transferred across in front of the removal station to which the detected person is moving.

At conventional drop-off and removal stations, luggage is dropped off and removed in the presence of security personnel. With the system/procedure described above, it is no longer necessary for security personnel to be present at each drop-off or removal station. In many cases it is sufficient for the security personnel to be responsible for a plurality of drop-off or removal stations. The system/method according to the invention is therefore also characterized by a significant reduction in personnel, since the drop-off and removal stations require little to no personnel.

Further embodiments and advantages of the invention are explained in more detail with reference to the following description and the drawings.

### In the Drawings:

FIG. 1 is a block diagram of the security inspection system,

FIG. 2 is a schematic view of the luggage loading region with a drop-off station,

FIG. 3 is a schematic view of the luggage retrieval region with a removal station,

FIG. 4 is a schematic plan view of the luggage retrieval region with a buffer and removal stations,

FIG. 5 is a schematic side view of the luggage retrieval region according to FIG. 4.

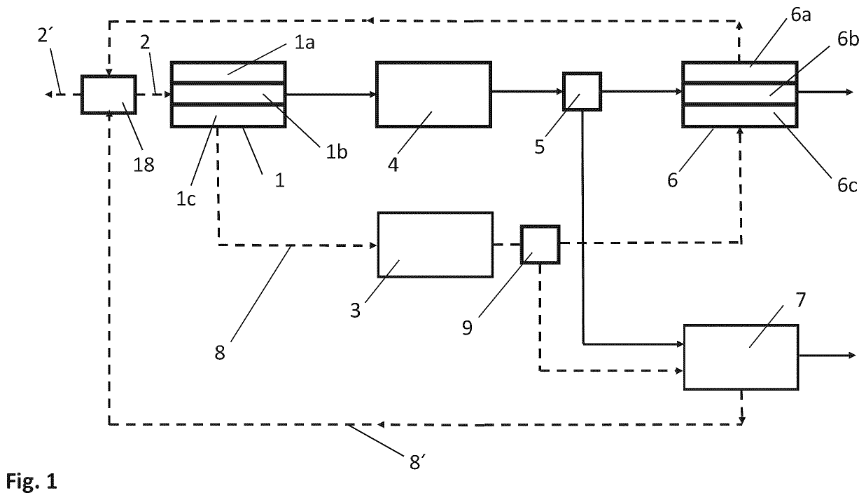

FIG. 1 shows a block diagram of an exemplary embodiment of a security inspection system according to the invention. It provides a luggage loading region 1 having one or more drop-off stations 1a, 1b, 1c for dropping off luggage into at least one load carrier 2. The load carrier 2 loaded with luggage is fed to a luggage inspection station 3 for imaging examination of the luggage, preferably using a computer tomograph.

During the luggage examination, the person goes to a people screening station 4. For example, metal detectors and body scan devices as well as other devices can be used.

The people screening station 4 preferably has queuing and routing systems that can specifically control synchronization between luggage status and people screening. Once the people screening has been completed, the person is detected at an information device 5, which is equipped with a further identification unit for detecting the personal identifier of the person standing in front of the information device 5, and then receives information as to whether they should proceed to a luggage retrieval region 6 having one or more removal stations 6a, 6b, 6c for receiving and emptying the load carrier assigned to the person, or to a follow-up inspection region 7 for manual follow-up inspection of their luggage. The passenger routes are illustrated in FIG. 1 with solid arrows.

Dashed arrows indicate a transport system 8 for transporting the load carriers 2 from the luggage loading region 1 via the luggage inspection station 3 to the luggage retrieval region 6 or to the follow-up inspection region 7 and a transport system 8′ for transporting back empty load carriers to the luggage loading region 1. After the luggage inspection station 3, a switch 9 is provided to divert the luggage rejected at the luggage inspection station 3 to the follow-up inspection region 7. By the time the switch is reached, the operator of the luggage inspection station (CT device) must have made their decision as to whether a follow-up inspection is necessary. If no decision is made in time, the load carrier 2 is automatically conveyed to the follow-up inspection region 7 so that rejected and non-rejected items of luggage are not mixed on the route to the luggage retrieval region 6.

In the region of the return transport route, a device 18 is provided for ejecting load carriers 2′ that are not completely emptied and/or soiled in order to prevent such load carriers from reaching one of the drop-off stations. Such load carriers are then transferred to a service or lost & found station. Since the load carriers are linked to the personal identifier of the associated person, the associated person can be specifically called and asked to go to the lost & found station.

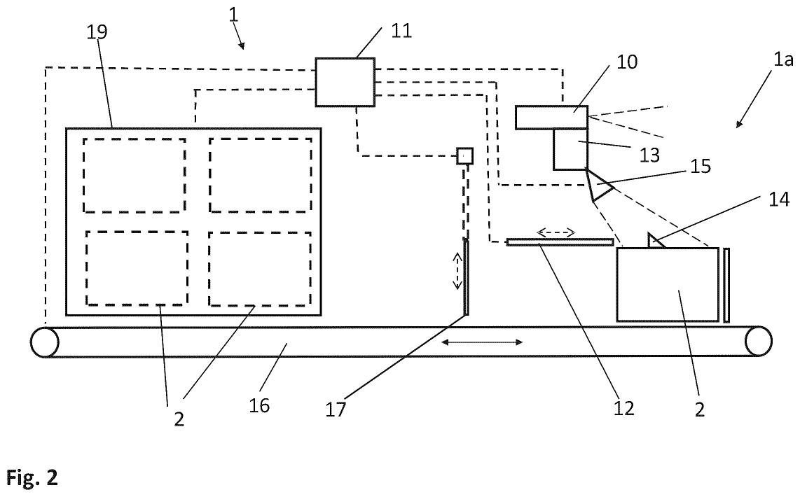

With reference to FIG. 2, the luggage loading region 1 is described in more detail below using the drop-off station 1a as an example. Thus, the drop-off station 1a has a first identification device 10 for detecting a personal identifier (in particular biometric characteristics) of the person, which is preferably designed as a camera. The personal identifier of the person is linked to the load carrier 2 provided at the drop-off station 1a by means of a data processing device 11, in which a label attached to the load carrier is read by a reading device (not shown in detail) and linked to the personal identifier of the person. The label on the load carrier can be formed, for example, by an RFID, a QR code or a similar identifier.

As soon as the person's personal identifier is detected, a cover 12 opens, releasing the load carrier 2 for loading. In the exemplary embodiment shown, the load carrier 2 is box-shaped and open at the top. The person can then stow their luggage in the load carrier 2, wherein visual and/or acoustic instructions can be given to the person via a first information device 13, which in particular comprises a monitor and a loudspeaker. In particular, it can be pointed out that a certain maximum load limit must not be exceeded. For this purpose, the load carrier can have a corresponding marking. However, it is also conceivable for the load carrier 2 to be loaded such that the luggage 14 does not exceed the dimensions of the load carrier 2.

A first monitoring device 15, which is formed by a camera, for example, recognizes the loading state of the load carrier 2, and in the event of an undesirable loading state, a corresponding instruction is given via the first information device 13. If the luggage 14 exceeds the dimensions of the load carrier 2 in the example shown, the person could be prompted to insert the luggage properly or to request a second load carrier. There is also the option to request help from a staff member if a person is having trouble.

If the luggage is properly stowed in the load carrier 2, the luggage drop-off process can be completed automatically by checking, in particular after a predetermined time, that there are no more people at the drop-off station 1a, so that automated removal of the load carrier 2 can be initiated. However, it could also be provided that the person closes the load carrier with a cover or lid. Alternatively, the process could also be completed by pressing a button or in a similar manner. If the person leaves the removal station without confirmation, they could be prompted to confirm via the first information device 13. Should the person nevertheless move away, which could possibly be prevented by a blockable exit, an automatic removal can also be initiated after a preset time has elapsed.

For removal, the cover 12 first closes and an optionally present gate 17 opens to allow the load carrier 2 to be removed. The load carrier 2 is transported via the transport system 8 and/or a providing system 16 connected to the transport system 8, wherein the first monitoring device 15 is coupled to the providing system 16 and/or the transport system 8 such that the removal of the load carrier 2 from the drop-off station 1a is blocked (cover 12 remains open and gate 17 remains closed) if an undesired loading state of the load carrier 2 is detected. The load carrier 2, properly loaded with luggage, is then fed to luggage inspection station 3, while the person proceeds to people screening station 4.

A buffer region 19 for returned, empty load carriers 2 is paired with the drop-off station 1a, wherein the next empty load carrier is provided in the drop-off station 1a via the transport system 8 or the providing system 16.

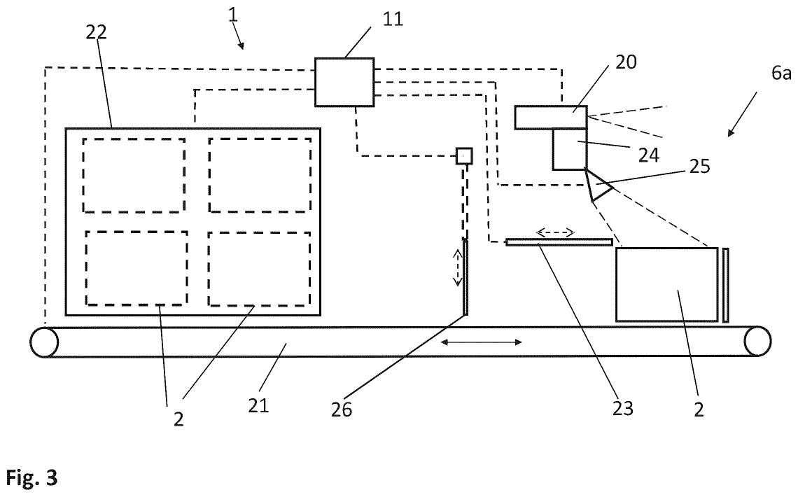

In the following, the luggage retrieval region 6 is explained in more detail with reference to FIG. 3, using the removal station 6a as an example.

The removal station 6a can in principle be constructed similarly or identically to the drop-off station 1a. Thus, the removal station 6a has a second identification device 20 for detecting the personal identifier of the person standing in front of the removal station, wherein the second identification unit 20 is linked to a second providing system 21 for transferring the load carrier 2 linked to the personal identifier of the person to this removal station 6a. For this purpose, the luggage retrieval region 6 has at least one buffer 22 for a plurality of load carriers 2 loaded with luggage, wherein a plurality of the removal stations, for example the removal stations 6a, 6b and 6c, are paired with the buffer 22. The second providing system 21 is designed to transfer the load carriers 2 loaded with luggage from the buffer 22 to one of the removal stations 6a, 6b, 6c, wherein the buffer 22—regardless of the order in which the load carriers 2 have been introduced in the buffer 22—is capable of transferring the load carriers 2 in any order to each of the corresponding removal stations 6a, 6b, 6c. The person wishing to collect their luggage can therefore go to any free removal station 6a, 6b, 6c and is identified there by the second identification device 20, so that the load carrier 2 linked to their personal identifier is transferred from the buffer 22 to this removal station.

As soon as the corresponding load carrier 2 is provided at the removal station, a cover 23 opens, making the load carrier 2 accessible for unloading. Information can be provided to the person via an input and/or output unit 24. A second monitoring device 25, which is formed for example by a camera, detects the loading state of the load carrier 2. The input and/or output unit 24 can be used to draw the person's attention to the fact that there are still items of luggage/objects in the load carrier 2. Once the retrieval is complete, it is possible, for example, to wish a good flight and/or to display the departure gate.

In an advantageous embodiment, a sensor unit, which is formed, for example, by the second identification unit 20, is provided at the existing removal stations, which sensor unit is designed to determine the presence of a person in front of the removal station and which is linked to the second monitoring unit 25 and the second providing system 21 such that the emptying process is completed by removing the emptied load carrier 2 if the sensor unit does not detect a person in front of the removal station 6a and the load carrier 2 is empty. In this way, the removal station can be made available to the next person as quickly as possible.

Once the removal process is completed, the cover 23 first closes and/or an optionally present gate 26 opens to allow the load carrier 2 to be removed. The load carrier 2 is transported via the second providing system 21 and/or the transport system 8, wherein the second monitoring device 25 is coupled to the second providing system 21 and/or the transport system 8 such that the removal of the load carrier 2 from the removal station 6a is blocked (cover 23 remains open and gate 26 remains closed) if there is still an object in the load carrier 2. If the load carrier 2 is empty, transporting back to the luggage loading region 1 is initiated. The next removal process can then be initiated by the second identification device 20 detecting the next person standing in front of the removal station.

According to a preferred embodiment of the invention, the second monitoring device 25 at the removal stations 6a, 6b, 6c may also be capable of detecting soiling of the load carrier 2, for example by a leaked liquid. Soiled load carriers could then be ejected at the device 18 (FIG. 1). An ejection could also occur in the case of a load carrier that is not or not completely emptied if the person were to move away from the removal station 6a, 6b, 6c before the load carrier is completely emptied.

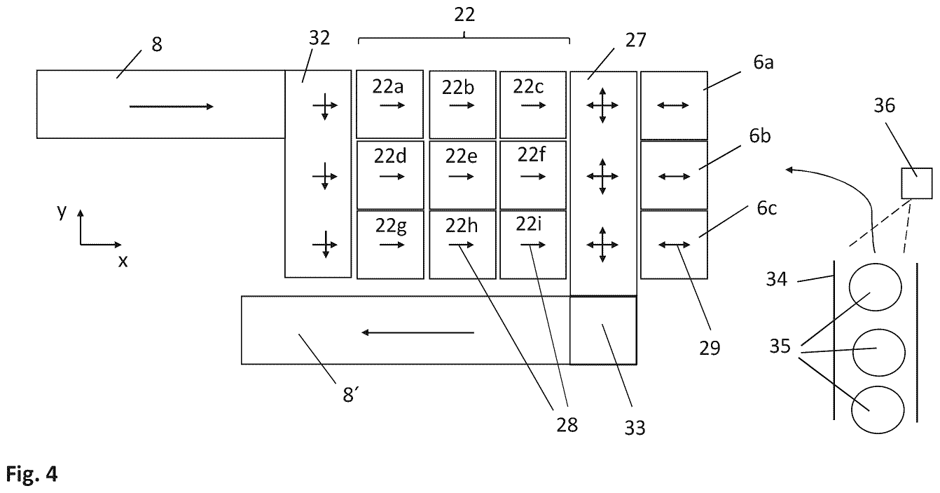

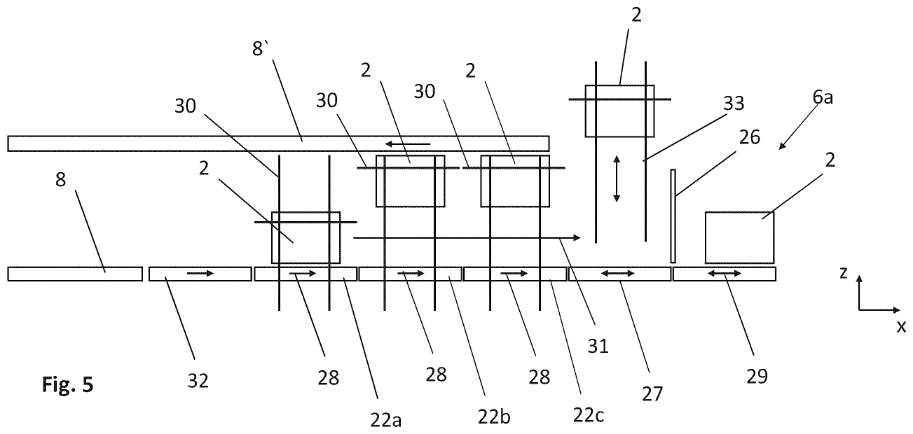

In the following, the provision of the load carriers 2 in the luggage retrieval region 6 is explained in more detail below with reference to FIGS. 4 and 5. The buffer 22 has a plurality of buffer spaces 22a-22i, which are preferably arranged in a plane, wherein the buffer provides, in particular, a plurality of parallel rows of buffers, each having a plurality of buffer spaces 22a-22c, 22d-22f and 22g-22c.

The second providing system 21 has a transfer unit 27 for moving the load carriers 2 in the x and y directions, wherein the transfer unit 27 is provided between the buffer 22 and the removal stations 6a, 6b, 6c and is designed to transfer the load carriers 2 fed from the buffer 22 to the transfer unit 27 to each of the removal stations 6a, 6b, 6c. The transfer of a requested load carrier 2 to one of the removal stations 6a, 6b, 6c preferably takes place in the same plane, which ensures a particularly fast transfer.

For transporting the load carriers 2 within the buffer 22, each buffer space 22a-22i is designed with a separately controllable conveyor unit 28 (schematically shown as an arrow) for moving the load carriers 2 in the x-direction. Furthermore, in each removal station 6a, 6b, 6c, a displacement unit 29 is provided for displacing the load carriers 2 between the removal station 6a, 6b, 6c and the transfer unit 27. In this way, the load carriers 2 can be conveyed in the x-direction from the buffer 22 to the transfer unit 27 and from there either further in the x-direction to the next removal station 6a, 6b, 6c or first in the y-direction up to the requesting removal station 6a, 6b, 6c and then transferred in the x-direction to this removal station 6a, 6b, 6c. The separately controllable conveyor units 28, the transfer unit 27 and the displacement units 29 together constitute the second providing system 21 and are designed in particular as belt or roller conveyors or as a combination of both conveyor types.

In the exemplary embodiment shown, in the buffer, the load carriers 2 can only be conveyed within a row, which is formed, for example, by the buffer spaces 22a, 22b and 22c. However, if, for example, a load carrier 2 located in the buffer space 22a is requested at the removal station 6a, the conveyor line may be blocked by load carriers 2 located in the buffer spaces 22b and/or 22c. In order to nevertheless allow the load carrier to be provided as quickly as possible by the buffer space 22a, the second providing system 21 provides lifting mechanisms 30 at the individual buffer spaces 22a-22i for lifting the associated load carriers 2 in the z-direction, wherein the lifting mechanisms 30 bring the load carriers 2 within a row of buffers into a raised position (see FIG. 5), wherein the clearance created during lifting is sufficient for passing other load carriers 2, in this case the load carrier in the buffer space 22a, underneath the load carriers in the raised position (arrow 31). In this way, load carriers 2 introduced into the buffer 22 later can overtake other load carriers introduced earlier if these are requested beforehand at one of the removal stations. In principle, instead of lifting a load carrier, it would of course also be conceivable to lower it in order to allow the load carriers therebehind to pass. In principle, it is not necessary for the rear buffer spaces 22a, 22d and 22g to be equipped with a lifting mechanism. However, if this is the case, even a load carrier 2 that is currently being transported by the transport system 8 to the buffer 22 could be transferred to one of the removal stations 6a, 6b, 6c. For introducing load carriers 2 into the buffer 22, a distribution device 32 is also provided, which is arranged between the transport system 8 and the buffer 22. Similar to the transfer unit 27, the distribution device 32 is designed to displace the load carriers 2 in the x and y-directions, thus allowing the next load carrier 2 to be introduced into each of the rows of buffers running in the x-direction.

Since there is usually only limited space available for the transport of the load carriers loaded with luggage and the empty load carriers to be returned, it makes sense for the transport system 8′ to be arranged at least partially in a second plane for transporting back the empty load carriers 2. In the exemplary embodiment shown (FIG. 5), the transfer unit 27 has at least one empty crate lifting mechanism 33, which is designed for transferring emptied load carriers 2 that have been displaced from the removal stations 6a, 6b, 6c to the transfer unit 27. The empty crate lifting mechanism 33 is connected to the transport system 8′ for transporting back the empty load carriers 2 to the luggage loading region 1.

In the luggage retrieval region 6, at least one waiting area 34 (FIG. 4) can also be provided for people 35 who wish to collect their luggage, wherein the waiting area 34 is paired with all existing removal stations or all removal stations, here 6a, 6b, 6c, paired with a zone and at least one third identification device 36 is provided in the waiting area 34, which identification device detects the personal identifier of at least the person who can go to one of the removal stations 6a, 6b, 6c next, and wherein the third identification device 36 interacts with the second providing system 21 for the accelerated transfer of the load carrier 2 linked to the personal identifier. The linked load carrier 2 could thus be conveyed forward onto the transfer unit 27 while the person is still in the waiting area or is currently moving to a free removal station. The load carrier 2 can then be transferred particularly quickly to the removal station 6a, 6b, 6c, to which this person then actually turns.

1. A security inspection system having
a luggage loading region (1) for loading luggage of a person into at least one load carrier (2),
a luggage inspection station (3) for an imaging examination of the luggage,
a luggage retrieval region (6) with at least one buffer (22) for multiple load carriers (2) loaded with luggage, wherein each buffer (22) is paired with a plurality of removal stations (6a, 6b, 6c) and a providing system (21) for transferring a load carrier (2) loaded with luggage from the buffer (22) to one of the removal stations (6a, 6b, 6c), and
a transport system (8, 8′) for transporting the load carriers loaded with luggage from the luggage loading region to the luggage retrieval region via the luggage inspection station and for transporting back empty load carriers to the luggage loading region,
characterized in that the providing system (21)—regardless of the order in which the load carriers (2) have been introduced into the buffer (22)—is designed to transfer each load carrier (2) loaded with luggage located in the buffer (22) in any order to each of the corresponding removal stations (6a, 6b, 6c).

2. The security inspection system according to claim 1, characterized in that the buffer (22) has a plurality of buffer spaces (22a-22i) arranged in a plane.

3. The security inspection system according to claim 1, characterized in that the buffer (22) has a plurality of parallel rows of buffers, each having a plurality of buffer spaces (22a-22b, 22d-22f, 22g-22i).

4. The security inspection system according to claim 1, characterized in that the providing system (21) has at least one conveyor unit (28) for displacing the load carriers (2) in the x-direction and at least one transfer unit (27) for displacing the load carriers (2) in the x- and y-directions, wherein the transfer unit (27) is provided between the buffer (22) and the removal stations (6a, 6b, 6c) and is designed to transfer the load carriers (2) fed from the buffer (22) to the transfer unit (27) to each of the removal stations (6a, 6b, 6c).

5. The security inspection system according to claim 3, characterized in that the providing system (21) has at least one lifting mechanism (30) for lifting one or more load carriers (2) in the z-direction, wherein the lifting mechanism (30) is designed to lift one or more load carriers (2) within a row of buffers into a raised position, wherein the clearance created during lifting is sufficient for passing other load carriers (2) below the load carrier (2) in the raised position.

6. The security inspection system according to claim 3, characterized in that the buffer (22) has a plurality of buffer spaces (22a-22i) and a plurality of removal stations (6a, 6b, 6c) are paired with the buffer (22), wherein at least twice as many buffer spaces are provided as removal stations (6a, 6b, 6c).

7. The security inspection system according to claim 1, characterized in that the buffer (22) has a plurality of buffer spaces (22a-22i), wherein each buffer space (22a-22i) is designed with a separately controllable conveyor unit (28) for displacing the load carriers (2) in the x-direction.

8. The security inspection system according to claim 4, characterized in that each removal station (6a, 6b, 6c) has a displacement unit (29) for displacing the load carriers (2) between the removal station (6a, 6b, 6c) and the transfer unit (27).

9. The security inspection system according to claim 7, characterized in that the transfer unit (27) cooperates with at least one empty crate lifting mechanism (33) that is designed to transfer emptied load carriers (2) that have been displaced from the removal stations (6a, 6b, 6c) to the transfer unit (27), wherein the empty crate lifting mechanism (33) is connected to a return transport route for transporting back empty load carriers (2) to the luggage loading region (1).

10. The security inspection system according to claim 1, characterized in that a first identification device (10) for detecting a personal identifier of the person is provided in the luggage loading region (1), which identification device interacts with a data processing device (11) for linking the personal identifier of the person with the load carrier (2) in which the person's luggage is located.

11. The security inspection system according to claim 10, characterized in that each removal station (6a, 6b, 6c) is equipped with a second identification device (20) for detecting the personal identifier of the person standing in front of the removal station (6a, 6b, 6c), wherein the second identification unit (20) is linked to the providing system (21) in order to transfer the load carrier (2) linked to the personal identifier of the person to this removal station (6a, 6b, 6c).

12. The security inspection system according to claim 11, characterized in that the luggage retrieval region (6) has at least one waiting area (34) for people who wish to collect their luggage, wherein the waiting area (34) is paired with the plurality of removal stations (6a, 6b, 6c) and at least one third identification device (36) is provided in the waiting area (34), which detects at least the personal identifier of the person who can go to one of the removal stations (6a, 6b, 6c) next, and wherein the third identification device (36) interacts with the providing system (21) for the accelerated transfer of the load carrier (2) linked to the personal identifier.

13. The security inspection system according to claim 12, characterized in that the luggage retrieval region (6) is divided into at least two zones, each having a buffer (22) with at least one removal station (6a, 6b, 6c) paired with the buffer (22).

14. The security inspection system according to claim 10, characterized in that
a people screening station (4) is provided between the luggage loading region (1) and the luggage retrieval region (6),
the luggage retrieval region (6) is designed for luggage not rejected in the luggage inspection station (3),
a follow-up inspection region (7) is provided for luggage rejected at the luggage inspection station (3), and
after the people screening station, an information device (5) having a further identification device for detecting the personal identifier of a person standing in front of the information unit (5) is provided, wherein the information unit (5) is further designed to provide an indication, wherein the indication indicates whether the luggage is provided in the luggage retrieval region (6) or in the follow-up inspection region (7).

15. A security inspection method, characterized in that a security inspection system according to claim 1 is used, wherein
in a luggage loading region (1), a person places their luggage in at least one load carrier (2),
the luggage in the load carrier (2) is subjected to an imaging examination in a luggage inspection station (3),
the load carrier (2) is transported with the luggage to a luggage retrieval region (6) having at least one buffer (22) for a plurality of load carriers (2) and introduced there, wherein the buffer (22) is paired with a plurality of removal stations (6a, 6b, 6c),
the load carrier (2) loaded with luggage is made available for emptying from the buffer (22) at a removal station (6a, 6b, 6c), and
the emptied load carriers (2) are transported back to the luggage loading region (1),
characterized in that-regardless of the order in which the load carriers (2) have been introduced into the buffer (22)—each load carrier (2) loaded with luggage located in the buffer (22) can be transferred in any order to each of the corresponding removal stations (6a, 6b, 6c).

16. The security inspection method according to claim 14, characterized in that, in the luggage loading region (1), a personal identifier of the person is detected by means of a first identification device (10) and is linked to the load carrier (2) in which the person's luggage is located.

17. The security inspection method according to claim 15, characterized in that the personal identifier of the person standing in front of one of the removal stations (6a, 6b, 6c) is detected by means of a second identification device (20) and the load carrier (2) linked to the personal identifier of the person is transferred from the buffer (22) to this removal station (6a, 6b, 6c).

18. The security inspection method according to claim 16, characterized in that the luggage retrieval region (6) has at least one waiting area (34) for people who wish to collect their luggage, wherein the waiting area (34) is paired with the plurality of removal stations (6a, 6b, 6c) and the personal identifier of at least the person who can go to one of the removal stations (6a, 6b, 6c) next is detected by means of a third identification device (36), wherein the transfer from the buffer (22) is already initiated before the person has moved to one of the removal stations (6a, 6b, 6c) in order to accelerate the provision of the load carrier (2) linked to the personal identifier of the person.
